(19) United States
(12) Patent Application Publication
(10) Pub. No.: US 2006/0233567 A1
(43) Pub. Date: Oct. 19, 2006

(54) Developing unit with reflection mirror and printing apparatus employing the same

(75) Inventor: Tai-eun Kwon, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd, Suwon-si (KR)

(21) Appl. No.: 11/384,503

(22) Filed: Mar. 21, 2006

(30) Foreign Application Priority Data
Apr. 15, 2005 (KR) 2005-31412

(51) Int. Cl. G03G 21/18

(52) U.S. Cl. 399/111

(57) ABSTRACT

A developing unit and a printing apparatus employing the same. A reflection mirror is installed in the developing unit at an angle to reflect an incident light beam toward an organic photoconductor (OPC) drum also installed in the developing unit. A latent image is formed on the surface of the OPC drum by the light beam.

### CROSS-REFERENCE TO RELATED PATENT APPLICATION

This application claims the benefit of Korean Patent Application No. 2005-31412, filed on Apr. 15, 2005, in the Korean Intellectual Property Office, the disclosure of which is incorporated herein in its entirety by reference.

### BACKGROUND OF THE INVENTION

1. Field of the Invention

Aspects of the present invention relate to a developing unit with a reflection mirror and a printing apparatus employing the same. More particularly, aspects of the present invention relate to a developing unit with a reflection mirror that is designed to minimize the size of a light scanning unit and a printing apparatus, and a printing apparatus employing the same.

2. Description of the Related Art

Printing apparatuses such as laser printers are image forming apparatuses in which a latent image formed on an organic photoconductor (OPC) drum is developed into a toner image and the toner image is transferred to a print medium such as paper. A laser printer includes a media feeder, a developing unit having an OPC drum to form a latent image thereon and develop the latent image into a toner image, a light scanning unit to scan a light beam across the OPC drum to form the latent image on the OPC drum, a transfer unit to transfer the toner image of the OPC drum to a print medium, a fusing unit to apply heat and pressure to the toner image transferred on the print medium to fix the toner image, and a medium discharging unit to discharge the print medium after printing.

FIG. 1 shows a positional relationship between a developing unit and a light scanning unit in a conventional laser printer. Referring to FIG. 1 and the corresponding reference numerals of each element, a laser printer 10 includes a light scanning unit 11 to scan a light beam to an OPC drum 17 and a developing unit 16 containing the OPC drum 17. The light scanning unit 11 includes a light source 12 to emit a light beam, a polygon mirror 13 rotating at a high speed to deflect the light beam from the light source 12 in a main scanning direction, an F-θ lens 14 to uniformly focus the deflected light beam onto the OPC drum 17, and a reflection mirror 15 to reflect the light beam from the F-θ lens 14 toward the OPC drum 17. The developing unit 16 is manufactured as a cartridge including a toner supply part and the OPC drum 17. Usually, the developing unit 16 is detachably installed in the laser printer 10. While on the other hand, the light scanning unit 11 is fixed in the laser printer 10. A laser light beam emitted from the light source 12 of the light scanning unit 11 is deflected in a main scanning direction by the polygon mirror 13 and scanned onto the OPC drum 17 of the developing unit 16 through the F-θ lens 14 and the reflection mirror 15. The developing unit 16 has a narrow aperture which allows the laser light from the light scanning unit 11 to enter the developing unit 16 and strike the OPC drum 17.

However, this structure requires a relatively large light scanning unit 11 because the reflection mirror 15 is disposed in the light scanning unit 11. Therefore, accommodating this light scanning unit 11 within the limited interior space of the laser printer 10 correspondingly requires the size of the laser printer to be relatively large. Further, according to the arrangement of the developing unit 16 and the light scanning unit 11 of the conventional printer as shown in FIG. 1, a light beam is projected above the OPC drum 17 to use the reflection mirror 15, thereby requiring a relatively tall laser printer 10, as well. Furthermore, when the light scanning unit 11 is installed at an angle to reduce the length of the laser printer 10, the height of the laser print 10 will increase further. In addition, because the aperture of the developing unit 16 must be very narrow to minimize exposure of the OPC drum 17 to ambient light, the laser beam path can be obstructed if the developing unit 16 is not accurately installed. Therefore, the laser printer 10 must be precisely manufactured to allow the developing unit 16 to be accurately installed.

FIG. 2 is a schematic sectional view showing a different positional relationship between a developing unit and a light scanning unit in another conventional printer. Referring to FIG. 2, a light beam emitted from a light source 22 of a light scanning unit 21 is projected onto an OPC drum 27 without being reflected by a reflection mirror. However, since the distance between the light scanning unit 21 and the OPC drum 27 must be kept equal to the long focal length of an F-θ lens 24 in the light scanning unit 21, this design results in a longer laser printer. Also, this laser printer still requires a precise structure to accommodate the developing unit 26 due to the same narrow aperture requirement as described above.

### SUMMARY OF THE INVENTION

An aspect of the present invention provides a developing unit that can minimize the size of a light scanning unit and a printing apparatus.

An aspect of the present invention also provides a printing apparatus that has a reduced size by employing the above developing unit.

According to an aspect of the present invention, there is provided a developing unit of a printing apparatus having an organic photoconductor (OPC) drum on a surface of which a latent image is formed when exposed to a light beam, the developing unit comprising a reflection mirror installed at an angle in the developing unit to reflect the light beam entering the developing unit toward the OPC drum.

In an embodiment of the present invention, the angle of the reflection mirror is adjustable to adjust to an initial printing position based on a reference such as a leading edge portion of a print medium.

According to an aspect of the present invention, the developing unit may further comprise: a charge roller uniformly charging the OPC drum; and a developing roller supplying toner to the OPC drum. The reflection mirror may be positioned in front of the charge roller to allow the OPC drum to be exposed to the light beam after being charged by the charge roller.

According to an aspect of the present invention, the OPC drum, the charge roller, the developing roller, and the reflection mirror may be installed in a single housing, and a window may be formed in a front side of the housing facing the reflection mirror to allow the light beam to enter the housing and reach the reflection mirror. In this case, the width of the window may be at least twice as large as the width of the light beam.

According to another aspect of the present invention, there is provided a printing apparatus comprising: a medium feeder to feed a print medium; a developing unit to form an image to be transferred to the print medium, including an OPC drum on a surface of which a latent image is formed when exposed to a light beam and a reflection mirror installed at an angle to reflect the light beam entering the developing unit toward the OPC drum; a light scanning unit to radiate the light beam onto the developing unit, including a light source to generate the light beam, a polygon mirror to deflect the light beam in a main scanning direction, and an F-θ lens to uniformly focus the deflected light beam onto the OPC drum; a transfer unit to transfer the image formed by the developing unit to the print medium; a fusing unit to fix the image transferred to the print medium using heat; and a medium discharge unit to discharge the print medium to which the image has been fixed.

According to an aspect of the present invention, iln the printing apparatus, the light scanning unit may be separated from the fusing unit by positioning the developing unit between these two units.

According to an aspect of the present invention, the light scanning unit may be placed substantially horizontally and emit the light beam substantially horizontally toward the reflection mirror in the developing unit.

### BRIEF DESCRIPTION OF THE DRAWINGS

The above and/or other features and advantages of the present invention will become more apparent by the following detailed description of the embodiments taken in conjunction with reference to the attached drawings in which:

FIG. 1 is a schematic sectional view of a conventional printer showing a positional relationship between a developing unit and a light scanning unit;

FIG. 2 is a schematic sectional view showing another positional relationship between a developing unit and a light scanning unit in a conventional printer;

FIG. 3 is a schematic sectional view showing a positional relationship between a developing unit and a light scanning unit according to an embodiment of the present invention; and

FIG. 4 illustrates a change in the light beam scanning position according to the rotation of a reflection mirror in a developing unit applicable to an aspect of the present invention.

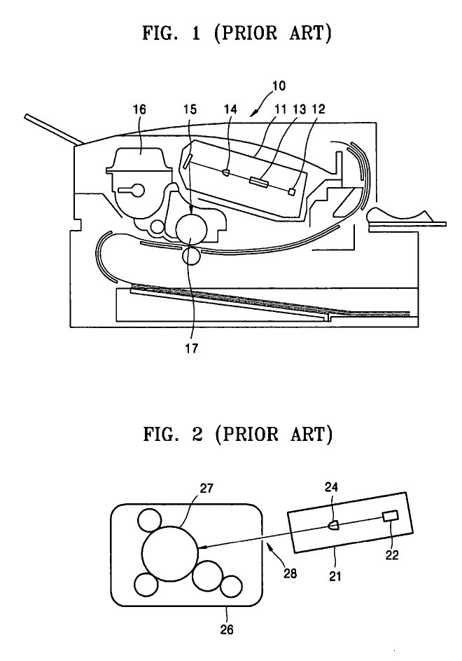

### DETAILED DESCRIPTION OF THE EMBODIMENTS

Hereinafter, aspects of the present invention will now be described in greater detail, examples of which are illustrated in the accompanying drawings, wherein like reference numerals refer to the like elements throughout. The embodiments are described below in order to explain the present invention by referring to the figures.

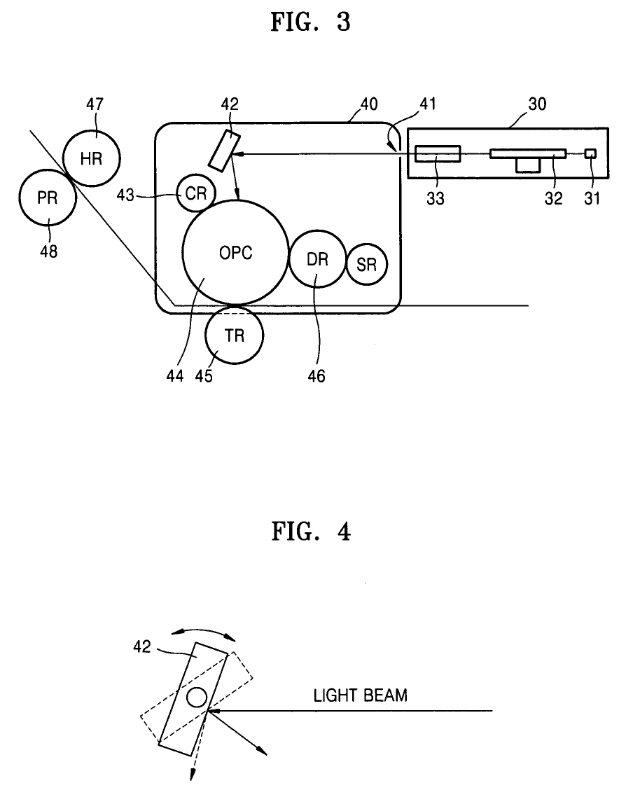

FIG. 3 is a schematic sectional view showing a positional relationship between a developing unit and a light scanning unit according to an embodiment of the present invention.

Referring to FIG. 3, according to an embodiment of the present invention, unlike in a conventional printer, a reflection mirror 42 is installed in a developing unit 40, not necessarily in a light scanning unit 30. That is, the light scanning unit 30 need only include main components, such as a light source 31, a polygon mirror 32, and an F-θ lens 33, thus reducing the size of the light scanning unit 30. The reflection mirror 42 is obliquely installed in the developing unit 40 to reflect a light beam emitted from the light scanning unit 30 toward an organic photoconductor (OPC) drum 44. That is, the developing unit 40 includes the OPC drum 44 on a surface of which an electrostatic latent image is formed by exposure to the light beam, the reflection mirror 42 obliquely installed to reflect the light beam toward the OPC drum 44, a charge roller 43 to uniformly charge the OPC drum 44, and a developing roller 46 to apply toner to the OPC drum 44. According to an aspect of the present invention, because the OPC drum 44 has to be exposed to the light beam after being charged by the charge roller 43, the reflection mirror 42 is placed in front of the charge roller 43, as shown in FIG. 3.

In the structure described above according to an aspect of the present invention, the size of the light scanning unit 30 can be minimized. Also, the distance between the developing unit 40 and the light scanning unit 30 can be reduced by increasing the optical path length of the light beam using the reflection mirror 42 installed in the developing unit 40. That is, although the distance between the developing unit 40 and the light scanning unit 30 is reduced, the optical path length between the OPC drum 44 and the light scanning unit 30 can be maintained to that required by the focal length of the F-θ lens 33. Therefore, by minimizing the size of the light scanning unit 30 and the distance between the light scanning unit 30 and the developing unit 40, the length of a printing apparatus can be minimized.

Although described as including one reflection mirror 42 in the developing unit 40, it is understood that the developing unit 40 can include a plurality of reflection mirrors according to other aspects of the invention. That is, the optical path length between the light scanning unit 30 and the OPC drum 44 can be maintained constant while further reducing the dimensions of the laser printer by using a second reflection mirror in the developing unit 40 such that an incident light beam on the first reflection mirror 42 is reflected to the second reflection mirror which then directs the light beam toward the OPC drum 44.

Further, according to an aspect of the present invention, since the size of the light scanning unit 30 can be minimized, it is not necessary to install the light scanning unit 30 at an incline to minimize the length of the printing apparatus. That is, as shown in FIG. 3, although the light scanning unit 30 is aligned nearly horizontally, the length of the printing apparatus does not increase. Also, since the light scanning unit 30 is aligned substantially horizontally and emits a light beam in a substantially horizontal direction toward the reflection mirror 42 in the developing unit 40, the height of the printing apparatus also can be minimized.

Although the above embodiment describes a light scanning unit 30 without a reflection mirror, it is understood that the present invention is not limited thereto. That is, according to other aspects of the invention, the light scanning unit 30 may contain a reflection mirror, for example, to allow the light scanning unit 30 to be installed vertically or at an incline. In such a case, the light beam emitted from the light scanning unit 30 would still strike the reflection mirror 42 in the developing unit 40 and reflect toward the OPC drum 44.

Further, according to an aspect of the present invention, the developing unit 40 is a cartridge type housing in which the OPC drum 44, the charge roller 43, the developing roller 46, and the reflection mirror 42 are installed. Therefore, the developing unit 40 can be detached from the printing apparatus. The housing has a window 41 in the front side thereof facing the reflection mirror 42 to allow the light beam from the light scanning unit 30 to pass through the housing and reach the reflection mirror 42.

According to the conventional art, since an incident light beam is reflected by a reflection mirror installed outside a developing unit before passing through a window to reache an OPC drum, the OPC drum is directly exposed to the outside ambient light from the window. Therefore, the width of the window must be very narrow to minimize exposure of the OPC drum to this ambient light leakage. However, according to an aspect of the present invention, an incident light beam first enters the developing unit 40 through the window 41 and is then reflected by the reflection mirror 42 installed in the developing unit 40 toward the OPC drum 44. Therefore, the OPC drum 44 is not exposed to outside ambient light through the window 41. Therefore, the window 41 of the developing unit 40 can have a relatively large width. For example, the width of the window 41 may be at least twice as large as the width of the light beam.

The increased width of the window 41 will allow the light beam to pass through the window 41 even when the developing unit 40 is not accurately installed. Also, since the reflection mirror 42 is installed relatively close to the OPC drum 44, the light beam can be easily adjusted to accurately scan the OPC drum 44 by rotation of the reflection mirror 42.

FIG. 4 illustrates a rotation of the reflection mirror 42 in the developing unit 40 to change the light beam scanning position. Referring to FIG. 4, in an embodiment according to the present invention, by adjusting the angle of the reflection mirror 42, an error in the displacement of an image printing position from a leading edge portion of a print medium can be corrected. Such an image displacement error may be caused by dimensional deviations of components, which can occur while manufacturing the components. That is, when a leading edge of a printed image is off-set from a desired location on a print medium, the leading edge of the printed image can be adjusted relative to a leading edge portion of a print medium by rotating the reflection mirror 42. For example, if an image is printed above a desired position on a print medium, the reflection mirror 42 is rotated clockwise, as shown in FIG. 4, to allow a light beam to scan closer to the charge roller 43. As a result, the initial printing position on the recording medium is moved away from the leading edge portion of the print medium and matches the desired printing position. The rotational adjustment of the reflection mirror 42 may be carried out in a number of ways such as during a process of assembling a printing apparatus or alternatively, a user may personally adjust the reflection mirror 42. For example, the rotation mirror 42 can be rotated by manually rotating a rotary shaft connected to the reflection mirror 42 or the rotation mirror 42 can be rotated automatically using printing apparatus control software controlling an adjustment motor.

The operation of a printing apparatus employing the light scanning unit 30 and the developing unit 40 will now be described with reference to FIG. 3.

When a print command is sent to the printing apparatus from, for example, a personal computer, a controller of the printing apparatus receives the command and controls corresponding units. First, the polygon mirror 32 of the light scanning unit 30 is rotated by a driving motor, and then a pick-up roller of a medium feeder (not shown) is rotated to feed a print medium. While the print medium is fed, the charge roller 43 of the developing unit 40 is rotated to charge the surface of the OPC drum 44 to a predetermined potential.

When the print medium arrives at a predetermined position, the light source 31 of the light scanning unit 30 emits a light beam toward the polygon mirror 32, which deflects the light beam in a main scanning direction. The deflected light beam comes out of the light scanning unit 30 through the F-θ lens 33 and enters the developing unit 40 through the window 41. The light beam is reflected by the reflection mirror 42 and scans the surface of the OPC drum 44 according to an image to be printed. As described above, the incident position of the light beam on the OPC drum 44 can be adjusted by changing the angle of the reflection mirror 42. In such a manner, an error in the displacement of an image printing position relative to a leading edge portion of a print medium can be corrected. As mentioned, these image displacement errors can be caused by dimensional deviations of components, which occur while manufacturing the components, but now can be corrected by adjusting the angle of the reflection mirror 42.

Meanwhile, when the surface of the OPC drum 44 is scanned by the light beam, a surface electric potential in the scanned surface portion of the OPC drum 44 is changed. As the developing roller 46 applies toner to the OPC drum 44, the toner is selectively attached only to the scanned surface portion of the OPC drum 44. The toner on the OPC drum 44 is transferred to the print medium by the transfer roller 45 and fused on the print medium by heat and pressure supplied by a heat roller 47 and a pressure roller 48, respectively. As a result, the image is printed on the print medium. The print medium on which the image has been printed is discharged out of the printing apparatus by a medium discharging unit (not shown).

In general, high-temperature heat is generated in a fusing unit which includes the pressure roller 48 and the hot roller 47. To prevent the temperature in the printing apparatus from rising due to this reason, a fan to discharge hot air out of the printing apparatus is installed in the printing apparatus. However, the temperature near the fusing unit is still high compared to the other areas of the printing apparatus. Therefore, if the light scanning unit 30 is placed near the fusing unit, the light scanning unit 30 can be affected by the high-temperature heat in the following way. Recently, F-θ lenses made of plastic are frequently used in light scanning units. F-θ lenses made of plastic easily deform in such a hot environment. For example, a light beam which has passed through an F-θ lens at a temperature of 60° C. is twice as large as when passing through the same F-θ lens at room temperature. As a result, the quality of the printed image is significantly deteriorated. An aspect of the present invention, as shown in FIG. 3, is that the light scanning unit 30 is separated from the fusing unit by the developing unit 40 positioned therebetween and emits a light beam toward the fusing unit. Because of this arrangement, the heat generated in the fusing unit has almost no effect on the light scanning unit 30.

As described above, according to an aspect of the present invention, since only main components, such as a light source, a polygon mirror, an F-θ lens, etc., are installed in the light scanning unit, the size of the light scanning unit can be minimized. In addition, because the optical path length of the light beam can be increased by a reflection mirror installed in the developing unit, the distance between the light scanning unit and the developing unit can also be reduced. Therefore, the length and the height of the printing apparatus can be minimized.

Further, since the reflection mirror is located relatively close to the OPC drum, there is little concern that a light beam travelling toward the OPC drum after being reflected by the reflection mirror will be blocked by other parts. Furthermore, an error in the displacement of an image printing position relative to a leading edge portion of a print medium caused by dimensional deviations of components, which can occur while manufacturing the components, can be corrected at the printer apparatus by an adjustment to the angle of the reflection mirror.

According to an aspect of the present invention, since the light scanning unit is separated from a fusing unit by the developing unit positioned therebetween, the light scanning unit is minimally affected by high-temperature heat generated by the fusing unit. Accordingly, the F-θ lens experiences minimal deformation and retains a small beam size as the light beam passing through it. Therefore, a high-quality image can be obtained.

While embodiments, aspects, and advantages of the present invention have been particularly shown and described these illustrations and descriptions are exemplary and are not to be construed as limiting the present invention. It will be understood by those of ordinary skill in the art that the present teaching can be readily applied to other apparatuses with various changes in form and details made therein without departing from the spirit and scope of the present invention as defined by the following claims.

What is claimed is:

1. A developing unit, comprising:
an OPC (organic photoconductor) drum on a surface of which a latent image is formed when exposed to a light beam; and
a reflection mirror installed at an angle in the developing unit to reflect the light beam entering the developing unit toward the OPC drum.

2. The developing unit of claim 1, wherein a plurality of reflection mirrors are installed at an angle so that the incident light beam is reflected to a subsequent mirror and from a last mirror toward the OPC drum.

3. The developing unit of claim 1, wherein the angle of the reflection mirror is adjustable to adjust an initial printing position on a leading edge portion of a print medium.

4. The developing unit of claim 2, wherein the angle of the last reflection mirror is adjustable to adjust an initial printing position on a leading edge portion of a print medium.

5. The developing unit of claim 3, further comprising a connecting member and a knob connected to the reflection mirror to adjust the angle of the reflection mirror.

6. The developing unit of claim 4, further comprising a connecting member and a knob connected to the last reflection mirror to adjust the angle of the last reflection mirror.

7. The developing unit of claim 1, further comprising:
a charge roller to uniformly charge the OPC drum; and
a developing roller to supply toner to the OPC drum.

8. The developing unit of claim 7, wherein the reflection mirror is placed in front of the charge roller to allow the OPC drum to be exposed to the light beam after being charged by the charge roller.

9. The developing unit of claim 8, wherein the OPC drum, the charge roller, the developing roller, and the reflection mirror are installed in a single housing, the developing unit further comprising:
a window in a front side of the housing facing the reflection mirror to allow the light beam to enter the housing and reach the reflection mirror.

10. The developing unit of claim 9, wherein a width of the window is at least twice as large as the width of the light beam.

11. The developing unit of claim 9, wherein the OPC drum is not exposed to ambient light through the window.

12. A printing apparatus comprising:
a medium feeder to feed a print medium;
a developing unit to form an image to be transferred to the print medium comprising:
an OPC drum on a surface of which a latent image is formed when exposed to a light beam, and
a reflection mirror installed at an angle to reflect the light beam entering the developing unit toward the OPC drum;
a light scanning unit to radiate the light beam onto the developing unit and comprising:
a light source to generate the light beam,
a polygon mirror to deflect the light beam in a main scanning direction of the print medium, and
an F-θ lens to uniformly focus the deflected light beam onto the OPC drum;
a transfer unit to transfer the image formed by the developing unit to the print medium;
a fusing unit to fix the image transferred to the print medium using heat; and
a medium discharging unit to discharge the print medium to which the image has been fixed.

13. The printing apparatus of claim 12, wherein a plurality of reflection mirrors are installed in the development unit at an angle so that the incident light beam is reflected toward a subsequent mirror and from a last mirror toward the OPC drum.

14. The printing apparatus of claim 12, wherein the light scanning unit excludes a reflection mirror.

15. The printing apparatus of claim 12, wherein the light scanning unit further comprises another reflection mirror installed at an angle in the light scanning unit.

16. The printing apparatus of claim 13, wherein the light scanning unit further comprises another reflection mirror installed at an angle in the light scanning unit.

17. The printing apparatus of claim 12, wherein the angle of the reflection mirror is adjustable to adjust an initial printing position on a leading edge portion of the print medium.

18. The printing apparatus of claim 13, wherein the angle of the last reflection mirror is adjustable to adjust an initial printing position on a leading edge portion of the print medium.

19. The developing unit of claim 17, wherein a control software program controls a drive mechanism to adjust the angle of the reflection mirror.

20. The developing unit of claim 18, wherein a control software program controls a drive mechanism to adjust the angle of the last reflection mirror.

21. The printing apparatus of claim 12, wherein the developing unit further comprises:
a charge roller to uniformly charge the OPC drum; and
a developing roller to supply toner to the OPC drum.

22. The printing apparatus of claim 21, wherein the reflection mirror is placed in front of the charge roller to allow the OPC drum to be exposed to the light beam after being charged by the charge roller.

23. The printing apparatus of claim 22, wherein the OPC drum, the charge roller, the developing roller, and the reflection mirror are installed in a single housing, comprising a window in a front side of the housing facing the reflection mirror to allow the light beam to enter the housing and reach the reflection mirror.

24. The printing apparatus of claim 23, wherein a width of the window is at least twice as large as a width of the light beam.

25. The printing apparatus of claim 23, wherein the OPC drum is not exposed to ambient light through the window.

26. The printing apparatus of claim 12, wherein the light scanning unit is separated from the fusing unit by the developing unit positioned therebetween.

27. The printing apparatus of claim 13, wherein the light scanning unit is separated from the fusing unit by the developing unit positioned therebetween.

28. The printing apparatus of claim 15, wherein the light scanning unit is separated from the fusing unit by the developing unit positioned therebetween.

29. The printing apparatus of claim 16, wherein the light scanning unit is separated from the fusing unit by the developing unit positioned therebetween.

30. The printing apparatus of claim 26, wherein the light scanning unit is substantially horizontally placed and emits the light beam substantially horizontally toward the reflection mirror in the developing unit.

31. The printing apparatus of claim 28, wherein the light scanning unit is substantially vertically placed and projects the light beam substantially vertically toward the reflection mirror placed at an angle in the light scanning unit and emits the light beam substantially horizontally toward the reflection mirror in the developing unit.

32. The printing apparatus of claim 28, wherein the light scanning unit is inclined and projects the light beam at an incline toward the reflection mirror placed at an angle in the light scanning unit and emits the light beam toward the reflection mirror in the developing unit.

33. The printing apparatus of claim 29, wherein the light scanning unit is substantially vertically placed and projects the light beam substantially vertically toward the reflection mirror placed at an angle in the light scanning unit and emits the light beam substantially horizontally toward the initial reflection mirror in the developing unit.

34. The printing apparatus of claim 29, wherein the light scanning unit is inclined and projects the light beam at an incline toward the reflection mirror placed at an angle in the light scanning unit and emits the light beam toward the initial reflection mirror in the developing unit.

35. A printing apparatus comprising:
a light scanning unit to radiate a light beam;
a developing unit to receive the light beam to form an image to be transferred to a print medium; and
a fusing unit to fix the image transferred to the print medium using heat and located on another other side of the developing unit from the light scanning unit so that the light scanning unit is substantially unaffected by the heat from the fusing unit.

36. A method of adjusting an image position on a print medium in a printing apparatus having a light scanning unit emitting a light beam toward a reflection mirror in a developing unit to reflect the light beam toward an OPC drum in the developing unit, comprising:
rotating an angle of a reflection mirror in the developing unit to cause a reflected light beam to strike an OPC drum in the developing unit at an advanced position; and
rotating the angle of the reflection mirror in the opposite direction to cause the reflected light beam to strike the OPC drum at a rearward or retarded position.

37. The method as defined in claim 36, further comprising:
adjusting the angle of the reflection mirror in the developing unit by manually rotating a knob.

38. The method as defined in claim 36, further comprising:
sending a command using a print control software to a stepping motor; and
adjusting the angle of the reflection mirror in the developing unit by rotating the stepping motor.

39. A method of printing an image on a print medium using a reflection mirror in a developing unit to reflect a light beam toward an OPC drum in the developing unit, comprising:
emitting a light beam from a light scanning unit;
admitting the light beam into a developing unit through a window facing a reflection mirror in the developing unit;
reflecting the light beam off the reflection mirror toward a surface of an OPC drum;
scanning the surface of the OPC drum according to an image to be printed;
applying toner to the OPC drum to develop the image; and
transferring the toner image to the print medium.
